(19) United States
(12) Patent Application Publication
(10) Pub. No.: US 2012/0114327 A1
(43) Pub. Date: May 10, 2012

(54) METHOD AND APPARATUS FOR ADAPTIVE OPTICAL WIRELESS COMMUNICATION

(75) Inventors: Tae-Han Bae, Seoul (KR); Hyuk-Choon Kwon, Seoul (KR); Jae-Seung Son, Suwon-si (KR); Do-Young Kim, Yongin-si (KR); Eun-Tae Won, Seoul (KR); Young-Kwon Cho, Suwon-si (KR)

(73) Assignee: Samsung Electronics Co., Ltd., Suwon-si (KR)

(21) Appl. No.: 13/291,558

(22) Filed: Nov. 8, 2011

(30) Foreign Application Priority Data
Nov. 8, 2010 (KR) 10-2010-0110676

(51) Int. Cl. H04B 10/00; H04B 10/08

(52) U.S. Cl. 398/9; 398/118

(57) ABSTRACT

An optical wireless communication device having a PhotoDiode (PD) for photosensitive detection means, receives a guide message from a specific optical wireless communication device, determines any one optical wireless communication scheme among different optical wireless communication schemes which are included in the guide message and supportable by the specific optical wireless communication device, as a content delivery scheme to be used during content reception, sends a response message including the content delivery scheme, and receives the content that is delivered based on the content delivery scheme.

### PRIORITY

This application claims priority under 35 U.S.C. §119(a) to a Korean Patent Application filed in the Korean Intellectual Property Office on Nov. 8, 2010 and assigned Serial No. 10-2010-0110676, the entire disclosure of which is incorporated herein by reference.

### BACKGROUND OF THE INVENTION

1. Field of the Invention

The present invention relates generally to optical communications, and more particularly, to a method and apparatus for adaptively performing communication using a variety of optical communication schemes.

2. Description of the Related Art

Due to the reduction of available Radio Frequency (RF) frequencies, the crosstalk issues between various wireless communication technologies, the increase in demand for communication security, and the advent of the high-speed ubiquitous communication environment based on 4^{th} Generation (4G) wireless technology, research and commercialization has focused on the optical wireless communications that use optical wireless technology which is complementary to the RF technology. Optical wireless communication may be applied even in hospitals and airplanes where the use of RF is limited, because it is low power and light-based communication. Examples of optical wireless communication may include Visible Light Communication (VLC), Infrared Data Association (IrDA), Image Sensor Communication (ISC), and the like.

VLC delivers information using visible light by a visible band as its transmission band, implementing a one-to-one communication.

### IRDA

IrDA delivers information using infrared light in an infrared band as its communication medium. Since the infrared band is an invisible band, the communication link is invisible. IrDA implements one-to-one communication, and is the currently commercialized technology.

ISC may perform communication using the visible band or the infrared band, and is featured by using image sensors as detection means for receiving light signals (or optical signals). Because of characteristics of the image sensors, ISC is useful for low-speed communication, and enables M-to-one (where M>1) communication since it can process multiple signals at the same time.

All of the optical wireless communications described above use light as a communication medium, such as a Light Emitting Diode (LED) as a light source. However, a communication band of the LED is different depending on the communication schemes.

A general structure of an optical wireless communication device supporting these optical wireless communications is illustrated in FIG. 1. Referring to FIG. 1, a VLC device includes a memory 11, a controller 12, an encoder 13, a modulator 14, a transmission (TX) driver 15, an LED 16, a decoder 18, a demodulator 19, a reception (RX) driver 20, and a photodiode (PD) 17.

The controller 12 processes data for VLC data transmission/reception, and controls the overall operation of the VLC device, including controlling the encoder 13 and the decoder 18.

The encoder 13 encodes the transmission data input from the controller 12, and outputs the encoded data to the modulator 14. The modulator 14 modulates the input transmission data and outputs the modulated data to the transmission driver 15.

The transmission driver 15 for the LED 16, optically modulates the transmission data input from the modulator 14 and drives the LED 16.

The LED 16, a light-emitting device provided to deliver transmission data to external devices using light signals, is driven by the transmission driver 15.

The PD 17, a photosensitive device sensing light signals received from the external devices, receives light signals including received data from a light source, converts the received light signals into electrical signals, and outputs them to the reception driver 20.

The reception driver 20, a driver for the PD 17, adjusts a wavelength detection band of the PD 17. The reception driver 20 outputs the electrical signals received from the PD 17 to the demodulator 19.

The demodulator 19 demodulates the electrical signals received from the reception driver 20 into data defined by the optical wireless communication scheme, and outputs the received data to the decoder 18.

The decoder 18 decodes the received data and outputs the decoded data to the controller 12. The controller 12 properly processes the received data provided from the decoder 18.

The memory 11 stores a processing and control program for the controller 12, reference data, and a variety of updatable data, and is provided as a working memory for the controller 12.

In this VLC device, the encoder 13, the modulator 14, the transmission driver 15, and the LED 16 are included in a transmitter, and the decoder 18, the demodulator 19, the reception driver 20, and the PD 17 are included in a receiver.

A basic optical wireless communication device may be constructed as described in the above structure. However, depending on its communication scheme, the optical wireless communication device may include an LED 16 having a different bandwidth, and its data processing by the controller 12 may be different depending on the communication scheme. The PD used as photosensitive means for sensing light signals may support a wide bandwidth including not only the visible light but also the infrared light.

As described above, although the different optical wireless communication schemes use the light as a communication medium, their bandwidths and data processing protocols may be different, thus enabling communication only between the optical wireless communication devices supporting the same communication scheme.

Accordingly, there is a need for an apparatus and method for enabling the communication between optical wireless communication devices supporting different communication schemes.

In addition, as the communication devices supporting various optical wireless communication schemes have been commercialized and deployed in the same area, it is preferable for the transmitting communication device to service or transmit the data regardless of the communication scheme supported by the receiving communication device. It is also preferable for the transmitting communication device to provide the service that has been optimized to the receiving communication device depending on the service environment.

### SUMMARY OF THE INVENTION

Accordingly, the present invention has been made to solve the above-stated problems occurring in the prior art, and the present invention provides an apparatus and method for enabling communication between optical wireless communication devices supporting different communication schemes.

According to an aspect of the present invention, there is provided an apparatus and method capable of transmitting data regardless of the communication scheme supported by the receiving optical wireless communication device.

According to another aspect of the present invention, there is provided an apparatus and method capable of providing data service optimized to the receiving optical wireless communication device.

According to an aspect of the present invention, there is provided a method for performing optical wireless communication in a first optical wireless communication device. The method includes receiving a data packet through photosensitive detection means which has response characteristics covering a frequency band used for each of multiple optical wireless communication schemes and in which the frequency band used for each of the multiple optical wireless communication schemes is set as a wavelength detection band; determining an optical wireless communication scheme corresponding to the data packet among the multiple optical wireless communication schemes; and processing the data packet using a communication protocol corresponding to the determined optical wireless communication scheme.

According to an aspect of the present invention, there is provided a first optical wireless communication device. The communication device includes photosensitive detection means which has response characteristics covering a frequency band used for each of multiple optical wireless communication schemes and in which the frequency band used for each of the multiple optical wireless communication schemes is set as a wavelength detection band; a memory for storing a communication protocol corresponding to each of the multiple optical wireless communication schemes; an adaptation processor for determining an optical wireless communication scheme corresponding to a data packet received through the photosensitive detection means among the multiple optical wireless communication schemes, and processing the data packet using a communication protocol corresponding to the determined optical wireless communication scheme; and a controller for processing the data packet received from the adaptation processor.

### BRIEF DESCRIPTION OF THE DRAWINGS

The above and other aspects, features and advantages of various embodiments of the present invention will be more apparent from the following description taken in conjunction with the accompanying drawings, in which:

FIG. 1 is a diagram illustrating a structure of a general optical wireless communication device;

FIG. 2 is a diagram illustrating response characteristics of a PD;

FIG. 3 is a diagram illustrating an optical wireless communication hierarchy according to an embodiment of the present invention;

FIG. 4 is a diagram illustrating a structure of an optical wireless communication device according to a first embodiment of the present invention;

FIG. 5 is a diagram illustrating a structure of an optical wireless communication device according to a second embodiment of the present invention;

FIGS. 6 and 7 are diagrams illustrating structures of adaptation processors according to an embodiment of the present invention;

FIG. 8 are diagrams illustrating operations of adaptation processors according to various embodiments of the present invention; and

FIGS. 9 to 11 are diagrams illustrating operations of optical wireless communication devices according to various embodiments of the present invention.

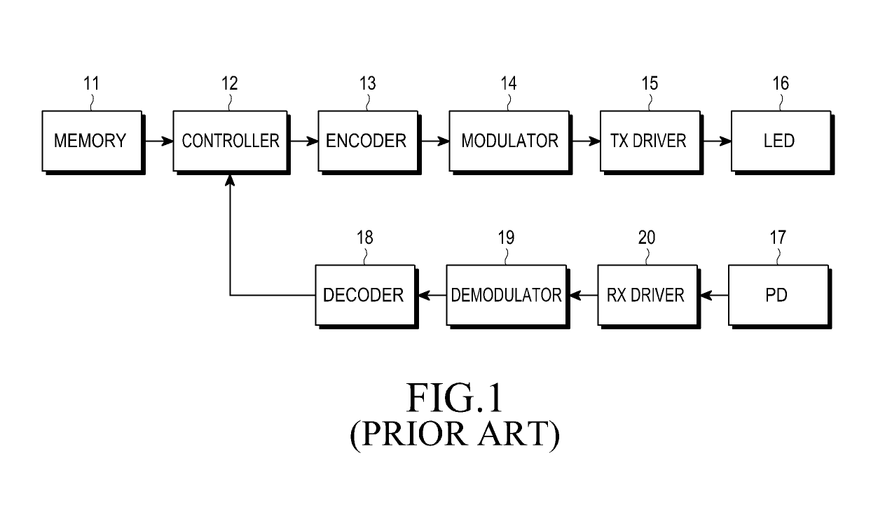

Throughout the drawings, the same drawing reference numerals will be understood to refer to the same elements, features and structures.

### DETAILED DESCRIPTION OF EMBODIMENTS OF THE PRESENT INVENTION

Embodiments of the present invention will be described in detail with reference to the accompanying drawings. In the following description, specific details such as detailed configuration and components are merely provided to assist in the overall understanding of the embodiments of the present invention. Therefore, it should be apparent to those of ordinary skill in the art that various changes and modifications of the embodiments described herein can be made without departing from the scope and spirit of the invention. In addition, descriptions of well-known functions and constructions are omitted for clarity and conciseness.

The present invention provides an apparatus and method for enabling communication between the optical wireless communication devices supporting different communication schemes, by using the feature that various optical wireless communication schemes use in common the light as a communication medium, and the feature that the PD serving as photosensitive detection means may support a wide bandwidth including not only the visible light but also the infrared light.

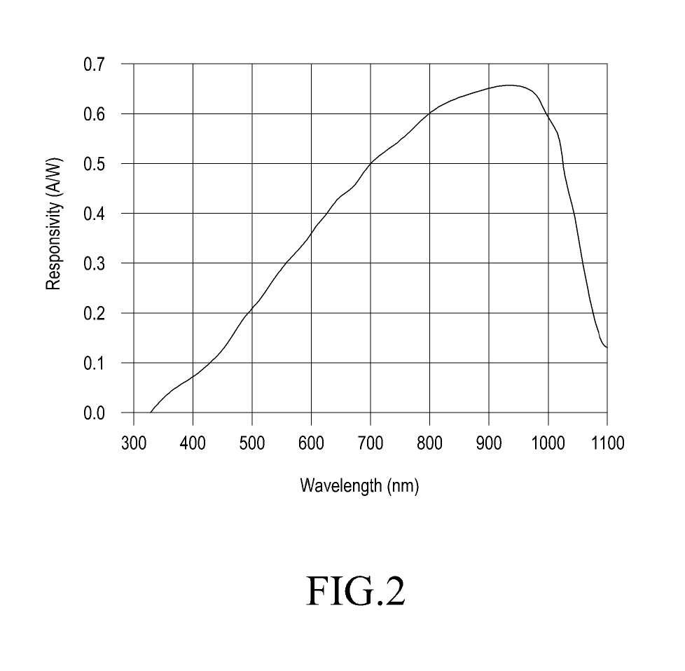

Generally, response characteristics (or responsivity) of the PD are as shown in FIG. 2. Referring to FIG. 2, it can be noted that though different wavelengths have different responsivities, the PD shows its response characteristics over the wide wavelength band. Therefore, one PD may sense all of light signals (or optical signals) transmitted by various optical wireless communication schemes, for example, VLC, IrDA, ISC, etc.

Accordingly, the optical wireless communication device provided by the present invention has a PD as photosensitive detection means. The optical wireless communication device, according to embodiments of the present invention, includes an adaptation layer and an adaptation layer management/control layer responsible for conversion and matching of data messages, so as to distinguish light signals sensed by a PD and generated by various optical wireless communication schemes, and to process data between the optical wireless communication schemes having different protocols.

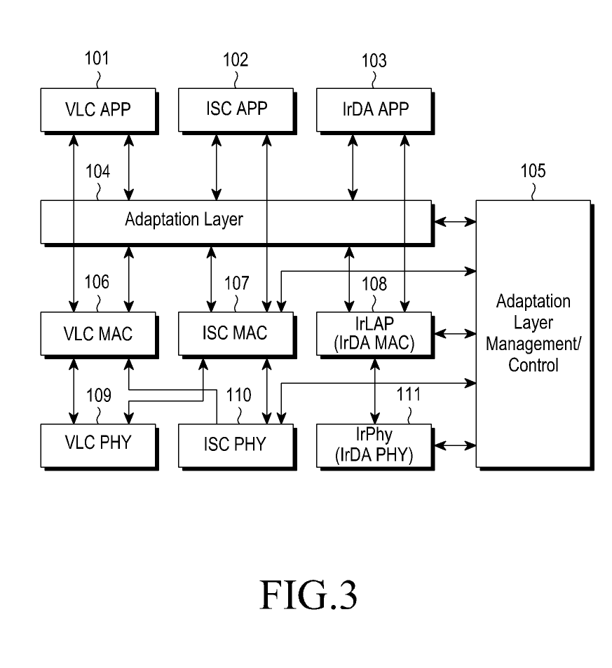

An optical wireless communication hierarchy according to an embodiment of the present invention is illustrated in FIG. 3. FIG. 3 is a diagram illustrating a hierarchical structure capable of data processing among a VLC protocol, an IrDA protocol and an ISC protocol according to an embodiment of the present invention.

Referring to FIG. 3, the optical wireless communication hierarchy provided by the present invention includes a VLC application layer 101, an ISC application layer 102, an IrDA application layer 103, an adaptation layer 104, an adaptation layer management/control layer 105, a VLC Media Access Control (MAC) layer 106, an ISC MAC layer 107, an IRDA MAC layer 108, a VLC physical (PHY) layer 109, an ISC PHY layer 110, and an IRDA PHY layer 111.

According to an embodiment of the present invention, the adaptation layer 104, an entity required to enable different optical wireless communications, for example, VLC, IrDA and ISC, in a single device, is disposed in an upper layer of the MAC layers 106, 107 and 108. This layer changes packet signals (i.e. performs translation and adaptation of packet formats) to match with different communication schemes before delivering the packet signals if necessary, or transforms (or performs packet adaptation on) packet signals received from one communication protocol to match with a communication protocol of the layer desiring to deliver the packet signals before delivering the packet signals.

Under control of the adaptation layer management/control layer 105, the adaptation layer 104 determines communication schemes corresponding to data messages provided from the VLC, ISC and IrDA MAC layers 106, 107 and 108, and delivers the data messages to their associated VLC, ISC and IrDA application layers 101, 102 and 103. The adaptation layer 104 may change formats of the data messages received from the VLC, ISC and IrDA MAC layers 106, 107 and 108 to allow the VLC, ISC and IrDA application layers 101, 102 and 103 to process the data messages. For example, the adaptation layer 104 changes a message format of IrDA data and delivers it to the VLC application layer 101 so that the VLC application layer 101 may process the data, or changes a message format of VLC data and delivers it to the ISC application layer 102 so that the ISC application layer 102 may process the data. The changing a message format may be performed at the request of the transmitting communication device, or may be performed even when no associated application layer is installed in the optical wireless communication device.

For control of the adaptation layer 104, the adaptation layer management/control layer 105 is required. The adaptation layer management/control layer 105, a layer for managing and controlling the adaptation layer 104 and the PHY and MAC layers of different communication schemes, determines whether use of different communication protocols is possible, or determines Quality of Service (QoS) thereof.

In this way, the present invention may provide the adaptation layer 104 and the adaptation layer management/control layer 105, allowing one communication device to process data depending on various communication schemes even though it includes only the message format translation-related protocols, instead of including all communication protocols for the seven layers corresponding to the various communication schemes.

That is, without the need to store all different protocols for each optical communication scheme in a storage unit of the communication device, the adaptation layer 104 and the adaptation layer management/control layer 105 may serve to simply deliver a command corresponding to each protocol, thus giving the effects that multiple protocols are provided, and saving a storage space of the storage unit.

The optical wireless communication device may be configured such that its data transmission scheme and data reception scheme may use different optical wireless communication schemes, since light-emitting means in a transmitter and photosensitive detection means in a receiver are implemented by separate devices due to their characteristics. Conventionally, all protocols for each of the two optical wireless communication schemes should be provided in the optical wireless communication device, whereas the optical wireless communication device according to embodiments of the present invention includes the adaptation layer 104 and the adaptation layer management/control layer 105, thereby making it possible to include only some protocols for any one optical wireless communication scheme, for communication.

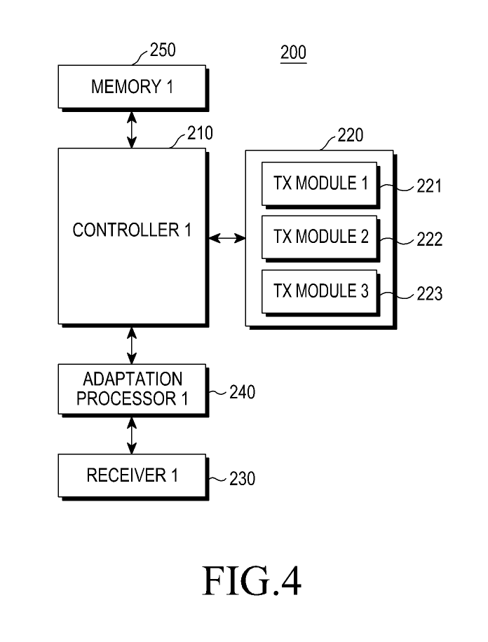

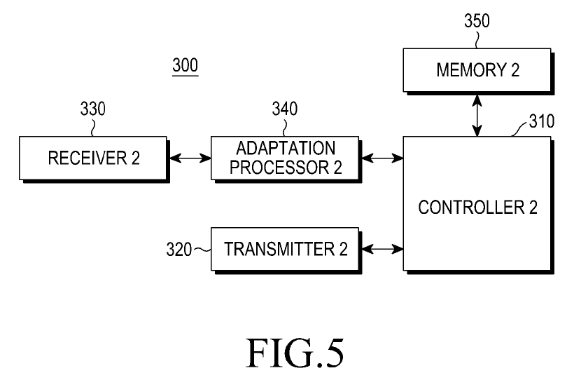

Examples of different optical wireless communication devices, to which the above communication hierarchy is applied, are illustrated in FIGS. 4 and 5. FIG. 4 is a diagram illustrating a structure of a first optical wireless communication device capable of data transmission/reception defined by various optical wireless communications according to a first embodiment of the present invention. FIG. 5 is a diagram illustrating a structure of a second optical wireless communication device, which can enable data reception corresponding to multiple communication schemes but supports a single optical wireless communication scheme for data transmission, according to a second embodiment of the present invention.

Referring to FIG. 4, a first optical wireless communication device 200 includes a first controller 210, a first transmitter 220, a first receiver 230, a first adaptation processor 240, and a first memory 250.

The first controller 210, controlling the overall operation of the first optical wireless communication device 200, controls the first transmitter 220, the first receiver 230, and the first adaptation processor 240, and accesses the first memory 250.

The first transmitter 220, under control of the first controller 210, encodes, modulates and transmits data received from the first controller 210. The first transmitter 220 includes transmission modules corresponding to various communication schemes supported by the first optical wireless communication device 200. Since optical wireless communications use different wavelength bands according to their types, types of LEDs used as light-emitting means may also be different. Therefore, an optical wireless communication device supporting multiple optical wireless communication schemes includes LEDs corresponding to the communication schemes and their associated driving devices. In the first embodiment of the present invention, the first optical wireless communication device 200 is assumed to support three different types of optical wireless communication schemes. Accordingly, the first transmitter 220 includes a first transmission module 221, a second transmission module 222, and a third transmission module 223. In accordance with an embodiment of the present invention, the first transmission module 221 may be a transmission module supporting VLC, the second transmission module 222 may be a transmission module supporting IrDA, and the third transmission module 223 may be a transmission module supporting ISC.

The first controller 210 may select a proper communication module among the transmission modules 221, 222 and 223 depending on multiple communication conditions or communication environments, and drive the selected communication module to perform optical wireless communication.

The first receiver 230, under control of the first controller 210, receives light signals through photosensitive detection means, demodulates and decodes the received light signals, and outputs the received data to the first adaptation processor 240. The first receiver 230 includes as the photosensitive detection means, for example, a PD having response characteristics covering the infrared band and the visible band. A wavelength detection band of the photosensitive detection means, i.e., PD, may be set to include the frequency band used for various optical wireless communications.

The first adaptation processor 240 stores application information of the communication scheme supported by the first optical wireless communication device 200, determines based thereon the type of optical wireless communication scheme by which the received data input from the first receiver 230 has been configured, and notifies the determination results to the first controller 210. The first adaptation processor 240 processes the received data packet and delivers it to the first controller 210. If the communication scheme applied to the received data packet is not the communication scheme supported by the first optical wireless communication device 200, the first adaptation processor 240 changes a format of the received data packet to a format of a communication protocol corresponding to the communication scheme supported by the first optical wireless communication device 200, and delivers the format-changed data packet to the first controller 210.

The first controller 210 selects an optical wireless communication application based on the determination results notified from the first adaptation processor 240, processes the received data, and drives the associated transmission module.

The first memory 250 stores a processing and control program for the first controller 210, reference data, various updatable data, records of hardware/software performance or specification, communication protocol and application data corresponding to various optical wireless communications, etc., and is provided as a working memory of the first controller 210.

Configured to enable multiple optical wireless communication schemes, the first optical wireless communication device 200 may determine the communication scheme supported by the receiving optical wireless communication device during its data transmission, and transmit the data according to the determined communication scheme. The first optical wireless communication device 200 may also transmit the data according to the communication scheme preferred by the receiving optical wireless communication device.

Though it supports a single optical wireless communication scheme during data transmission, a second optical wireless communication device 300 shown in FIG. 5 may receive and process data defined by various optical wireless communication schemes, since it includes an adaptation processor 340 and a controller 310 serving as the adaptation layer 104 and the adaptation layer management/control layer 105 according to an embodiment of the present invention.

Referring to FIG. 5, the second optical wireless communication device 300 includes a second controller 310, a second transmitter 320, a second receiver 330, a second adaptation processor 340, and a second memory 350 according to the second embodiment of the present invention for a device supporting a single optical wireless communication scheme.

The second controller 310, controlling the overall operation of the second optical wireless communication device 300, controls the second transmitter 320, the second receiver 330 and the second adaptation processor 340, and accesses the second memory 350.

The second transmitter 320, under control of the second controller 310, encodes and modulates data input from the second controller 310, and transmits the modulated data. The second transmitter 320 includes an LED covering a wavelength band used for the optical wireless communication scheme supported by the second optical wireless communication device 300, and its associated driving device.

The second receiver 330, under control of the second controller 310, receives light signals through photosensitive detection means, demodulates and decodes the received light signals, and outputs the received data to the second adaptation processor 340. The second receiver 330 includes as the photosensitive detection means, for example, a PD having response characteristics covering the infrared band and the visible band. A wavelength detection band of the photosensitive detection means, i.e., PD, may be set to include the frequency band used for various optical wireless communications.

The second adaptation processor 340 stores application information of various communication schemes, and determines based thereon the type of the optical wireless communication scheme by which the received data input from the second receiver 330 has been configured. If the determined communication scheme is an optical wireless communication scheme supported by the second optical wireless communication device 300, the second adaptation processor 340 outputs the received data to the second controller 310. However, if the determined communication scheme is not a communication scheme supported by the second optical wireless communication device 300, the second adaptation processor 340 changes a message format of the received data to a message format corresponding to the optical wireless communication scheme supported by the second optical wireless communication device 300, and outputs the format-changed data to the second controller 310.

The second controller 310 processes the received data input from the second adaptation processor 340.

The second memory 350 stores a processing and control program for the second controller 310, reference data, various updatable data, records of hardware/software performance or specifications, communication protocol and application data corresponding to various optical wireless communications, etc., and is provided as a working memory of the first controller 310.

In the first optical wireless communication device 200 and the second optical wireless communication device 300, although the adaptation processors 240 and 340 and the controllers 210 and 310 are provided as separate components, the adaptation processors 240 and 340 may be included in the controllers 210 and 310.

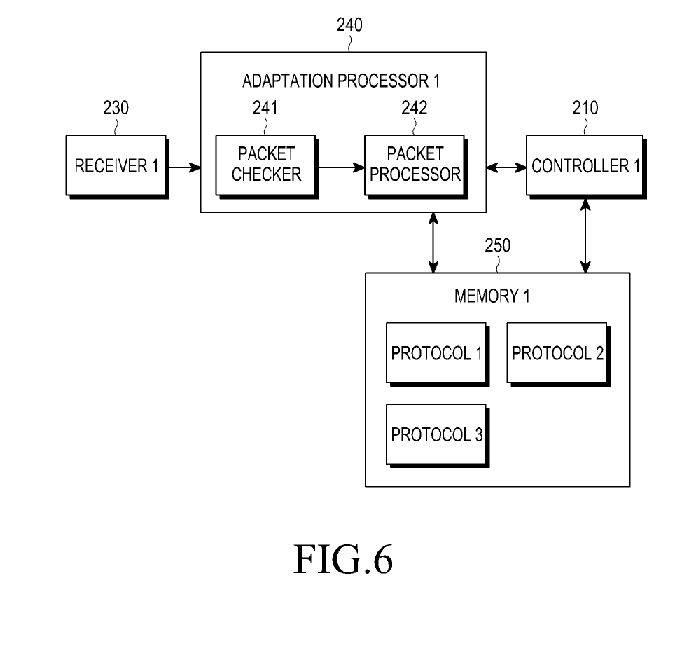

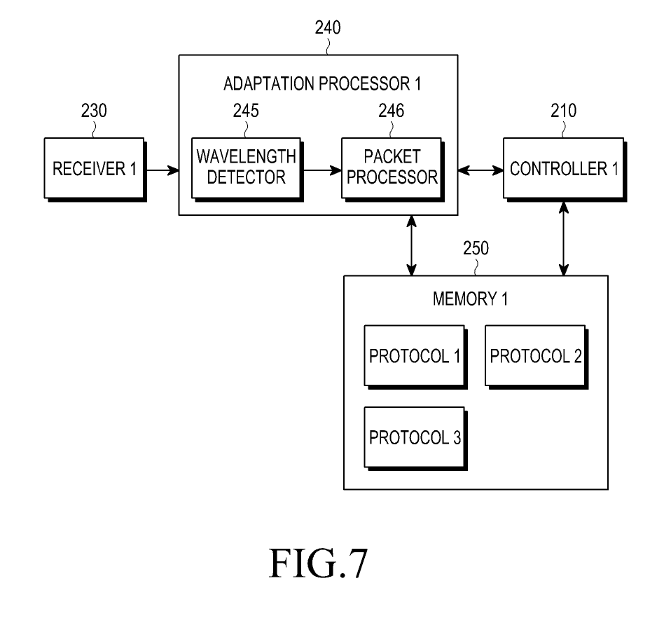

In accordance with an embodiment of the present invention, the adaptation processors 240 and 340 may be configured as shown in FIGS. 6 and 7, and a process of processing the received data packet by the adaptation processors 240 and 340 is as follows. Although FIGS. 6 and 7 show an example of the first adaptation processor 240 in the first optical wireless communication device 200 for convenience only, the same may be applied to the second adaptation processor 340 in the second optical wireless communication device 300.

Referring to FIG. 6, the first adaptation processor 240 includes a packet checker 241 and a packet processor 242.

The packet checker 241 checks the received data packet input from the first receiver 230 and determines the communication scheme applied to the received data packet. The packet processor 242 processes the received data packet according to the communication scheme checked by the packet checker 241.

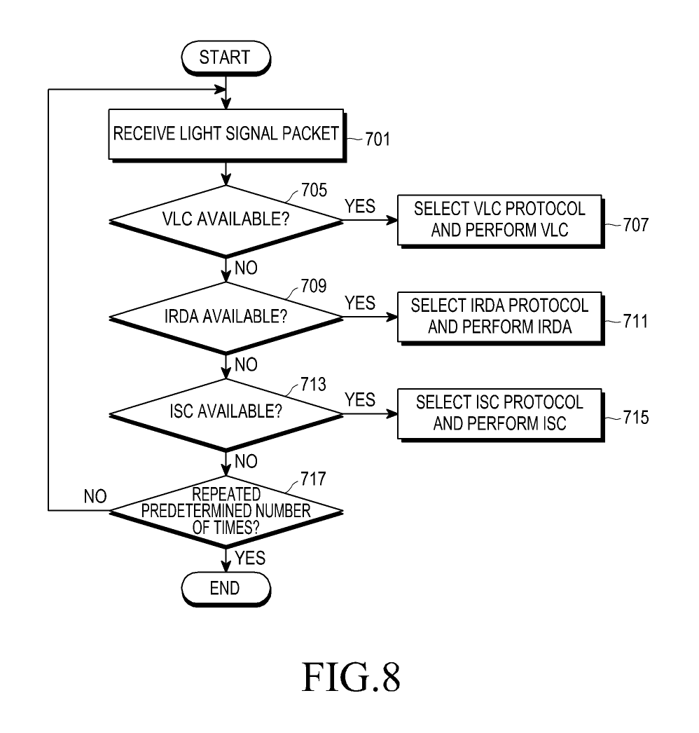

The first memory 250 stores communication protocols (e.g., a first protocol, a second protocol and a third protocol) corresponding to three different communication schemes. It is assumed that the first protocol is a VLC communication protocol, the second protocol is an IrDA communication protocol, and the third protocol is an ISC communication protocol. An operation of the packet checker 241 will be described with reference to FIG. 8.

Referring to FIG. 8, if the first optical wireless communication device 200 receives a light signal packet in step 701, the first adaptation processor 240 determines through the packet checker 241 whether the communication scheme applied to the received packet is any one of the single or multiple optical wireless communication schemes supported by the first optical wireless communication device 200. That is, the packet checker 241 sequentially applies the first to third protocols stored in the first memory 250 to the received packet, and determines a protocol capable of processing the received packet.

In step 705, the packet checker 241 checks the received signal packet and determines whether the received signal packet is a VLC packet. If the communication protocol applied to the received packet is identical to the VLC protocol, the packet checker 241 selects the VLC protocol and processes the received packet using the VLC protocol by means of the packet processor 242, in step 707. If the first optical wireless communication device 200 stores a VLC communication application, the packet processor 242 delivers the received packet to the first controller 210 without format change. Otherwise, the packet processor 242 changes a format of the received packet to a format corresponding to the communication scheme supported by the first optical wireless communication device 200, and delivers the format-changed packet to the first controller 210. If the first optical wireless communication device 200 includes a transmission module supporting VLC, the future communication may be performed by VLC.

If the received signal packet is not a VLC packet in step 705, the packet checker 241 checks the received signal packet and determines whether the received packet is an IrDA packet, in step 709. If the communication protocol applied to the received packet is identical to the IrDA protocol, the packet checker 241 selects the IrDA protocol and processes the received packet using the IrDA protocol by means of the packet processor 242, in step 711. If the first optical wireless communication device 200 stores an IrDA communication application, the packet processor 242 delivers the received packet to the first controller 210 without format change. Otherwise, the packet processor 242 changes a format of the received packet to a format corresponding to the communication scheme supported by the first optical wireless communication device 200, and delivers the format-changed packet to the first controller 210. If the first optical wireless communication device 200 includes a transmission module supporting IrDA, the future communication may be performed by IrDA.

If the received signal packet is not an IrDA packet in step 709, the packet checker 241 checks the received signal packet and determines whether the received packet is an ISC packet, in step 713. If the communication protocol applied to the received packet is identical to the ISC protocol, the packet checker 241 selects the ISC protocol and processes the received packet using the ISC protocol by means of the packet processor 242, in step 715. If the first optical wireless communication device 200 stores an ISC communication application, the packet processor 242 delivers the received packet to the first controller 210 without format change. Otherwise, the packet processor 242 changes a format of the received packet to a format corresponding to the communication scheme supported by the first optical wireless communication device 200, and delivers the format-changed packet to the first controller 210. If the first optical wireless communication device 200 includes a transmission module supporting ISC, the future communication may be performed by ISC.

Upon failure to determine the ISC communication protocol in step 713, the packet checker 241 repeats the operation of receiving a light signal and determining a communication protocol, a predetermined number of times in step 717.

FIG. 7 is a diagram illustrating a structure of the adaptation processor 240 (or 340) when the optical wireless communication device 200 (or 300) checks a wavelength of a received light signal and determines to which communication scheme the received packet corresponds. Referring to FIG. 7, the first adaptation processor 240 includes a wavelength detector 245 and a packet processor 246. The packet processor 246 is similar in operation to the packet processor 242.

The first receiver 230 receives a light signal, and sends the received signal to the wavelength detector 245. The wavelength detector 245 detects a wavelength of the received light signal, distinguishes a signal in a visible band from a signal in an infrared band, and sends the results to the packet processor 246. As a wavelength of the visible band ranges from about 380 nm to about 780 nm, and a wavelength of the infrared band ranges from about 800 nm to about 900 nm, the wavelength detector 245 may distinguish them. After determining whether the received signal is a signal in the infrared band based on the results from the wavelength detector 245, the packet processor 246 selects an IrDA protocol and processes the received packet.

If the received signal is a signal in the visible band, the wavelength detector 245 performs the process of checking a communication packet as in FIG. 8, because it may correspond to VLC or ISC.

For example, assuming that the hardware and communication protocol capable of ISC are not installed in the first optical wireless communication device 200 and the first optical wireless communication device 200 supports VLC and IrDA, the first optical wireless communication device 200 may fast select a communication scheme by means of the wavelength detector 245.

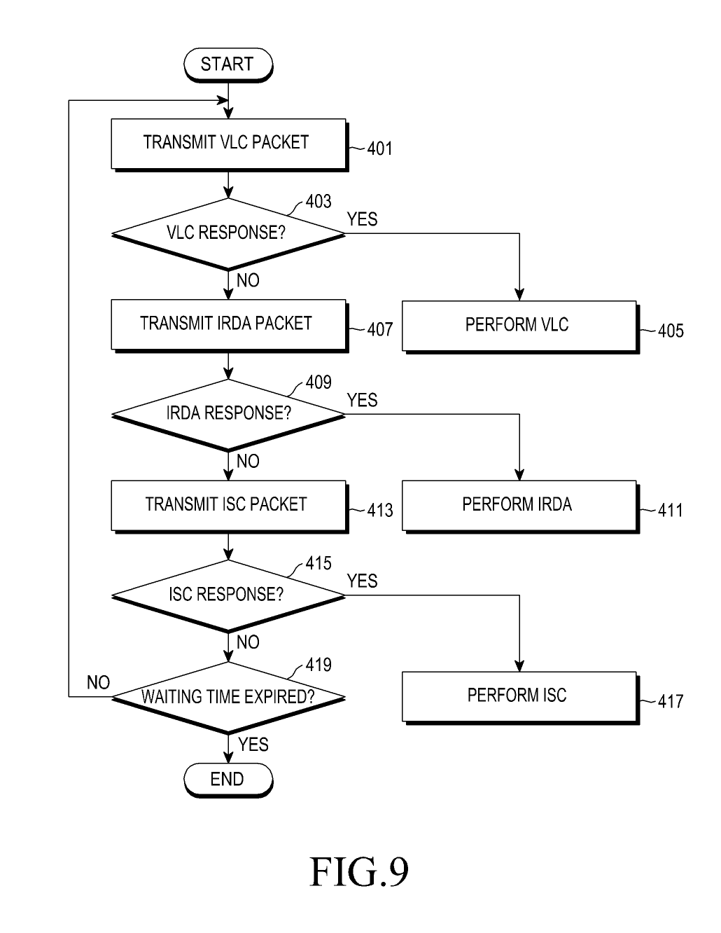

In accordance with an embodiment of the present invention, in order to perform optical wireless communication with an adjacent optical wireless communication device, an optical wireless communication device broadcasts a guide message for guiding start of communication, and transmits data using the communication scheme supported by the optical wireless communication device upon receiving a response message to the guide message, thereby making it possible to perform communication. Such optical wireless communication may be performed, for example, between the first optical wireless communication device 200 and the conventional optical wireless communication device, between the first optical wireless communication device 200 and the second optical wireless communication device 300, or between the second optical wireless communication devices 300. These various optical wireless communication processes will be described below with reference to FIGS. 9 to 11. FIGS. 9 to 11 are diagrams illustrating processes of performing communication by the first optical wireless communication device 200 and the second optical wireless communication device 300 according to different embodiments of the present invention.

The process of performing communication with a conventional optical wireless communication device by the first optical wireless communication device 200 according to an embodiment of the present invention is described below. The conventional optical wireless communication device refers to a communication device without an adaptation processor, and means a device that cannot process the data corresponding to the communication scheme it does not support. The first optical wireless communication device 200 configures a guide message according to each communication scheme and broadcasts the guide message, since it can transmit data using various optical wireless communication schemes. Accordingly, even though an adjacent optical wireless communication device is the conventional communication device, i.e., a communication device with no adaptation processor, if it is a communication device supporting at least one of multiple optical wireless communication schemes supported by the first optical wireless communication device 200, the optical wireless communication device may receive the guide message corresponding to the communication scheme supported by the optical wireless communication device. Upon receiving the guide message, the optical wireless communication device may configure a response message according to the communication scheme supported by the device itself, and send the response message. Accordingly, the first optical wireless communication device 200 may perform optical communication by processing and transmitting the content data it desires to transmit according to the communication scheme. This process is illustrated in FIG. 9.

Referring to FIG. 9, the first optical wireless communication device 200 configures a guide message in a VLC packet and transmits the VLC packet using the first transmission module 221 in step 401. If there is an adjacent optical wireless communication device supporting VLC, the optical wireless communication device may receive the guide message and send a response message to the guide message.

The response message is delivered to the first adaptation processor 240 through the first receiver 230, and the first adaptation processor 240 determines in step 403 whether the response message is a VLC response by checking a message format of the response message. The process of checking a response message by the first adaptation processor 240 is as follows. Upon determining by the first adaptation processor 240 that the received response is a VLC response, the first optical wireless communication device 200 performs VLC in step 405. That is, in step 405, the first optical wireless communication device 200 performs the future optical wireless communication using the first transmission module 221.

If there is no VLC response for a predetermined time, the first optical wireless communication device 200 configures a guide message in an IrDA packet and transmits the IrDA packet in step 407. In step 409, like in step 403, the first optical wireless communication device 200 determines whether an IrDA response is received within a predetermined time. Upon receiving an IrDA response, the first optical wireless communication device 200 performs IrDA by configuring the content it desires to deliver, according to the IrDA scheme, and delivering the IrDA content in step 411.

Upon failure to receive an IrDA response within a predetermined time in step 409, the first optical wireless communication device 200 configures a guide message in an ISC packet and transmits the ISC packet in step 413. In step 415, the first optical wireless communication device 200 determines whether an ISC response is received within a predetermined time. Upon receiving an ISC response, the first optical wireless communication device 200 performs ISC by configuring the content it desires to deliver, according to the ISC scheme, and delivering the ISC content in step 417. Upon failure to receive an ISC response within a predetermined time in step 415, the first optical wireless communication device 200 determines in step 419 whether the entire waiting time has expired. If the entire waiting time has expired, the first optical wireless communication device 200 stops the communication attempt. However, if the entire waiting time has not expired, the first optical wireless communication device 200 returns to step 401 and repeats its succeeding steps.

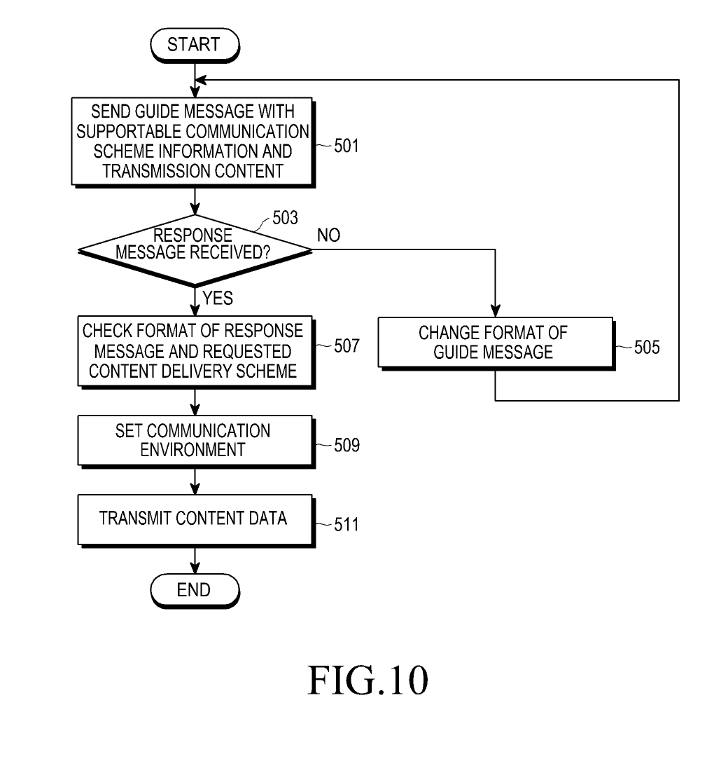

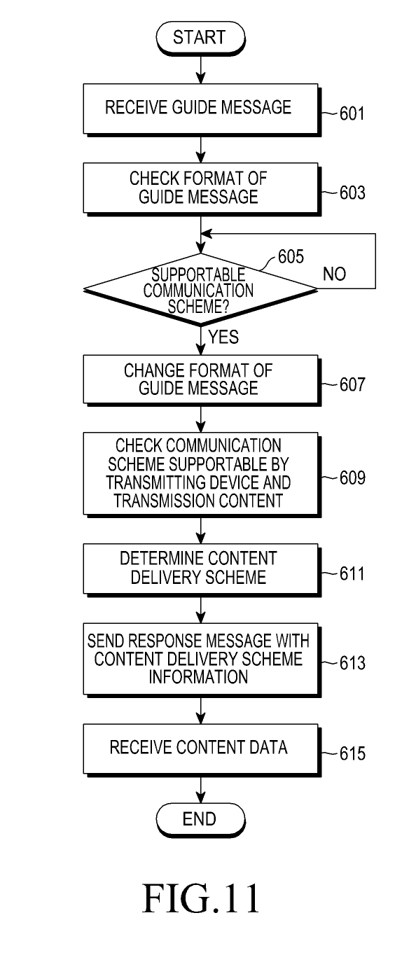

FIGS. 10 and 11 are diagrams illustrating a process of performing optical wireless communication between the first optical wireless communication device 200 and the second optical wireless communication device 300 according to an embodiment of the present invention. FIG. 10 is a diagram illustrating an operation of the first optical wireless communication device 200, and FIG. 11 is a diagram illustrating an operation of the second optical wireless communication device 300. It is assumed that the first optical wireless communication device 200 is a transmitting device and the second optical wireless communication device 300 is a receiving device. The second optical wireless communication device 300, since it includes the second adaptation processor 340, may check information included in a guide message even though a message format of the received guide message does not correspond to the communication scheme the second optical wireless communication device 300 supports during data transmission. For a better understanding of the present invention, it is assumed in the examples of FIGS. 10 and 11 that a data transmission scheme of the second optical wireless communication device 300 is IrDA.

Referring to FIG. 10, the first optical wireless communication device 200 configures a guide message including information about supportable communication schemes and information about content to be delivered, and broadcast the guide message, in step 501. In accordance with an embodiment of the present invention, the information about supportable communication schemes may include types of multiple communication schemes supportable by the first optical wireless communication device 200, for example, VLC, IrDA and ISC, and the information about content to be delivered may include size, type and importance of the content. The message format of the guide message may be one of the supportable communication schemes, e.g., VLC, IrDA and ISC.

Accordingly, the second optical wireless communication device 300 receives the guide message through the second receiver 330 in step 601 of FIG. 11. The second receiver 330 outputs the guide message to the second adaptation processor 340.

In step 603, the second adaptation processor 340 determines whether a message format of the guide message corresponds to the communication scheme the second optical wireless communication device 300 uses during data transmission. This is because that it is assumed in this embodiment that the second optical wireless communication device 300 transmits data using a single optical wireless communication scheme, and in this case, the communication scheme it uses during data transmission is the main communication scheme of the second optical wireless communication device 300. If the number of optical wireless communication schemes supported by the second optical wireless communication device 300 is plural, one of them may be designated as a main communication scheme. Next, it may be determined in step 605 whether a format of the guide message corresponds to the designated main communication scheme. In this embodiment, it is determined whether the message format corresponds to IrDA.

If it is determined in step 605 that the guide message has an IrDA message format, the second adaptation processor 340 outputs the guide message to the second controller 310 as it is (without format change), in step 609. However, if the guide message does not have an IrDA message format, the second adaptation processor 340 changes the message format to match with the IrDA protocol in step 607, and then delivers the guide message to the second controller 310 in step 609.

In step 609, the second controller 310 checks information about the communication scheme supportably by the transmitting device, i.e., the first optical wireless communication device 200, and about the content to be delivered. In step 611, the second controller 310 determines a content delivery scheme. The content delivery scheme may be determined as the main communication scheme (i.e., IrDA) of the second optical wireless communication device 300, or may be determined as another communication scheme. This is because a PD provided in the second receiver 330 as photosensitive means may receive signals in any wavelength band, and the second adaptation processor 340 may properly process data in a message format corresponding to a communication scheme other than IrDA and deliver the data to the second controller 310. Accordingly, the criteria for determining the content delivery scheme may include the type, size and importance of the content, and the current communication environment. For example, if the content to be delivered is large in size, it is preferable for the content to be delivered by VLC. If an interference signal affecting VLC or ISC is detected at around, it is preferable for the content to be delivered by IrDA. The second controller 310 determines a proper transmission scheme taking into account these current conditions. In this embodiment, it is assumed that the content delivery scheme is determined as VLC.

Thereafter, in step 613, the second controller 310 configures a response message with content transmission scheme information in an IrDA message format and sends it.

Referring back to FIG. 10, in step 503, the first optical wireless communication device 200 may receive the response message sent in step 613. If the response message is not received in step 503, the first optical wireless communication device 200 changes a message format of the guide message in step 505, and resends the guide message in step 501.

Upon receiving the response message in step 503, the first optical wireless communication device 200 checks a message format of the response message and checks a content delivery scheme included in the response message, in step 507. By checking a message format of the response message, the first optical wireless communication device 200 may determine the type of the communication scheme supported by the receiving communication device. In step 509, the first optical wireless communication device 200 sets the communication environment corresponding to the communication scheme supported by the receiving communication device and the requested content delivery scheme. In this embodiment, the communication environment will be set such that data reception in the second optical wireless communication device 300 is achieved by IrDA and the content to be delivered is delivered by VLC.

The first optical wireless communication device 200 delivers content to the second optical wireless communication device 300 according to VLC in step 511, and the second optical wireless communication device 300 receives the content in step 615.

As a message format of the content received in step 615 is changed according to an IrDA protocol by the second adaptation processor 340, and delivered to the controller 310, the content may be normally processed.

In accordance with an embodiment of the present invention, optical communication may also be performed between optical wireless communications devices configured like the second optical wireless communication device 300. That is, even though the communication scheme supporting data transmission is a single communication scheme, as the optical wireless communication devices include an adaptation processor, data communication is possible between the communication devices which are not limited in the message format of the received data. Even though the two wireless communication devices are different from each other in data transmission scheme, the optical communication may be normally achieved.

Here, supportable communication scheme information included in a guide message from a transmitting second optical wireless communication device 300 includes only a single optical wireless communication scheme supported by the transmitting second optical wireless communication device 300. A response message sent by a receiving second optical wireless communication device 300 includes a single optical wireless communication scheme that the transmitting second optical wireless communication device 300 supports as a content delivery scheme. The communication environment between the two second optical wireless communication devices 300 is properly set according to the information in the message. That is, the communication device determines and recognizes in advance the communication scheme for the data the other party's device will transmit, thereby enabling actual transmission/reception of content.

For example, assume that the transmitting second optical wireless communication device 300 supports only VLC during data transmission, and the receiving second optical wireless communication device 300 supports only IrDA during data transmission. By exchanging a guide message and a response message, the two devices may determine the other party's data transmission scheme and may set a communication environment corresponding thereto. The transmitting second optical wireless communication device 300 transmits data by VLC, and receives by IrDA the data transmitted from the receiving second optical wireless communication device 300. The transmitting second optical wireless communication device 300 may efficiently process the received data by means of the second adaptation processor 340. This may be achieved similarly even in the receiving second optical wireless communication device 300.

Accordingly, the present invention enables communication between optical wireless communication devices supporting different communication schemes. In addition, the optical wireless communication device according to the present invention may transmit data regardless of the communication scheme supported by the receiving optical wireless communication device, and may provide data service optimized to the receiving optical wireless communication device.

While the invention has been shown and described with reference to various embodiments thereof, it will be understood by those skilled in the art that various changes in form and details may be made therein without departing from the spirit and scope of the invention as defined by the appended claims.

What is claimed is:

1. A method for performing optical wireless communication in a first optical wireless communication device, comprising:
receiving a data packet through photosensitive detection means which has response characteristics covering a frequency band used for each of multiple optical wireless communication schemes and in which the frequency band used for each of the multiple optical wireless communication schemes is set as a wavelength detection band;
determining an optical wireless communication scheme corresponding to the data packet among the multiple optical wireless communication schemes; and
processing the data packet using a communication protocol corresponding to the determined optical wireless communication scheme.

2. The method of claim 1, wherein determining the optical wireless communication scheme comprises:
sequentially applying multiple communication protocols corresponding individually to the multiple optical wireless communication schemes, to the data packet; and
determining a communication protocol as being identical to a communication protocol applied to the data packet.

3. The method of claim 1, wherein determining the optical wireless communication scheme comprises:
upon receiving a light signal corresponding to the data packet, detecting a signal wavelength of the light signal; and
determining a specific optical wireless communication scheme that uses a frequency band corresponding to the signal wavelength, as an optical wireless communication scheme corresponding to the data packet.

4. The method of claim 3, further comprising:
if there is a plurality of specific optical wireless communication schemes, sequentially applying multiple communication protocols corresponding individually to the plurality of specific optical wireless communication schemes, to the data packet and determining a communication protocol as being identical to a communication protocol applied to the data packet.

5. The method of claim 1, further comprising:
if the data packet is a guide message sent from a second optical wireless communication device, determining any one optical wireless communication scheme among one or more optical wireless communication schemes which are included in the guide message and supportable by the second optical wireless communication device, as a content delivery scheme to be used during content reception;
sending a response message including the content delivery scheme; and
receiving the content that is delivered based on the content delivery scheme.

6. The method of claim 5, wherein if a format of the guide message does not correspond to a communication application supported by the first optical wireless communication device, the format of the guide message is changed to a format of a communication protocol supported by the first optical wireless communication device, and then processed.

7. The method of claim 5, wherein the content delivery scheme is determined depending on a type of an ambient interference signal.

8. The method of claim 7, wherein the guide message includes information about the content, and the content delivery scheme is determined based on the information about the content.

9. The method of claim 5, further comprising:
if there is data to be transmitted to a third optical wireless communication device, configuring and broadcasting a guide message including information about an optical wireless communication scheme supportable by the first optical wireless communication device;
receiving a response message corresponding to the broadcasted guide message; and
transmitting the data based on the content delivery scheme included in the received response message.

10. The method of claim 9, wherein the first optical wireless communication device supports multiple different optical wireless communication schemes, and upon failure to receive the response message corresponding to the broadcasted guide message, resends the broadcasted guide message after changing a format thereof.

11. A first optical wireless communication device comprising:
photosensitive detection means which has response characteristics covering a frequency band used for each of multiple optical wireless communication schemes and in which the frequency band used for each of the multiple optical wireless communication schemes is set as a wavelength detection band;
a memory for storing a communication protocol corresponding to each of the multiple optical wireless communication schemes;
an adaptation processor for determining an optical wireless communication scheme corresponding to a data packet received through the photosensitive detection means among the multiple optical wireless communication schemes, and processing the data packet using a communication protocol corresponding to the determined optical wireless communication scheme; and
a controller for processing the data packet received from the adaptation processor.

12. The first optical wireless communication device of claim 11, wherein the adaptation processor comprises:
a packet checker for sequentially applying multiple communication protocols corresponding individually to the multiple optical wireless communication schemes, to the data packet and determining a communication protocol as being identical to a communication protocol applied to the data packet; and
a packet processor for processing the data packet using the identical communication protocol.

13. The first optical wireless communication device of claim 11, wherein the adaptation processor comprises:
a wavelength detector for detecting a signal wavelength of a light signal upon receiving the light signal corresponding to the data packet; and
a packet processor for determining a specific optical wireless communication scheme that uses a frequency band corresponding to the signal wavelength, as an optical wireless communication scheme corresponding to the data packet, and processing the data packet.

14. The first optical wireless communication device of claim 13, wherein if there is a plurality of the specific optical wireless communication schemes, the packet processor sequentially applies multiple communication protocols corresponding individually to the plurality of the specific optical wireless communication schemes, to the data packet and determines a communication protocol as being identical to a communication protocol applied to the data packet.

15. The first optical wireless communication device of claim 11, wherein if the data packet is a guide message sent from a second optical wireless communication device, the controller determines any one optical wireless communication scheme among one or more optical wireless communication schemes which are included in the guide message and supportable by the second optical wireless communication device, as a content delivery scheme to be used during content reception, sends a response message including the content delivery scheme, and processes the content that is received from the second optical wireless communication device based on the content delivery scheme.

16. The first optical wireless communication device of claim 11, wherein if a format of the guide message does not correspond to a communication application supported by the first optical wireless communication device, the adaptation processor changes the format of the guide message to a format of a communication protocol supported by the first optical wireless communication device, and outputs the format-changed guide message to the controller.

17. The first optical wireless communication device of claim 15, wherein the content delivery scheme is determined depending on a type of an ambient interference signal.

18. The first optical wireless communication device of claim 17, wherein the guide message includes information about the content, and the content delivery scheme is determined based on the information about the content.

19. The first optical wireless communication device of claim 18, wherein if there is data to be transmitted to a third optical wireless communication device, the controller configures a guide message including information about an optical wireless communication scheme supportable by the first optical wireless communication device, broadcasts the guide message, and transmits the data based on the content delivery scheme included in a response message received in response to the broadcasted guide message.

20. The first optical wireless communication device of claim 19, further comprising:
a transmitter for supporting multiple different optical wireless communication schemes,
wherein upon failure to receive the response message corresponding to the broadcasted guide message, the controller resends the broadcasted guide message after changing a format thereof.
